(19) United States
(12) Patent Application Publication
(10) Pub. No.: US 2023/0089656 A1
(43) Pub. Date: Mar. 23, 2023

(54) PROCESS FOR PRODUCING SYNTHESIS GAS WITH REDUCED STEAM EXPORT

(71) Applicant: L'Air Liquide, Société Anonyme pour l'Etude et l'Exploitation des Procédés Georges claude, Paris (FR)

(72) Inventors: Charline GALLIOT, Frankfurt am Main (DE); Marion David, Jouy-en-Josas (FR); Teja Schmid McGuinness, Frankfurt am Main (DE)

(21) Appl. No.: 17/949,410

(22) Filed: Sep. 21, 2022

(30) Foreign Application Priority Data
Sep. 22, 2021 (EP) 21020475.6

(51) Int. Cl. C01B 3/38

(52) U.S. Cl. CPC C01B 3/388

(57) ABSTRACT

A process is proposed for producing synthesis gas with reduced steam export by catalytic steam reforming of a hydrocarbonaceous feed gas with steam in a multitude of reformer tubes in a burner-heated reformer furnace to form a steam reforming flue gas. This process includes a configuration of the reformer tubes as reformer tubes with internal heat exchange and the use of a structured catalyst. For amounts of export steam between 0 and 0.8 kg of export steam per m_{N}³ of hydrogen produced, these features interact synergistically when particular steam reforming conditions are selected.

### CROSS REFERENCE TO RELATED APPLICATIONS

This application claims the benefit of priority under 35 U.S.C. § 119 (a) and (b) to European Patent Application No. 21020475.6, filed Sep. 22, 2021, the entire contents of which are incorporated herein by reference.

### FIELD OF THE INVENTION

The invention relates to a process for producing a synthesis gas containing hydrogen and carbon oxides with reduced steam export by catalytic steam reforming of a hydrocarbonaceous feed gas, preferably natural gas, with steam under steam reforming conditions in a multitude of reformer tubes in a burner-heated reformer furnace to form a steam reforming flue gas.

### PRIOR ART

Hydrocarbons can be catalytically reacted with steam to give synthesis gas, i.e. mixtures of hydrogen (H₂) and carbon monoxide (CO). As is explained in Ullmann's Encyclopedia of Industrial Chemistry, Sixth Edition, 1998 Electronic Release, under “Gas Production”, this method, called steam reforming, is the hitherto most commonly employed method for the production of synthesis gas, which can then be converted to further important commodity chemicals such as methanol or ammonia. While different hydrocarbons, such as naphtha, liquid gas or refinery gases, can be converted, it is steam reforming of methane-containing natural gas that dominates.

Steam reforming of natural gas is highly endothermic. It is therefore performed in a reformer furnace in which numerous catalyst-containing reformer tubes in which the steam reforming reaction takes place are arranged in parallel. The outer walls of the reformer furnace and its roof and floor are faced or lined with a plurality of layers of refractory material which withstands temperatures of up to 1200° C. The reformer tubes are usually fired with burners which are mounted on the top or bottom or on the side walls of the reformer furnace and directly fire the interspace between the reformer tubes. Heat transfer to the reformer tubes is effected by heat radiation and convective heat transfer from the hot flue gases.

After preheating by heat exchangers or fired heaters to at least about 500° C., the hydrocarbon-steam mixture enters the reformer tubes after final heating to about 500° C. to 1000° C. and is converted therein to carbon monoxide and hydrogen over the reforming catalyst. Nickel-based reforming catalysts are in widespread use. While higher hydrocarbons are converted fully to carbon monoxide and hydrogen, partial conversion is typical in the case of methane. The composition of the product gas is determined by the reaction equilibrium; the product gas thus contains not only carbon monoxide and hydrogen but also carbon dioxide, unconverted methane and water vapour. For energy optimization or for feedstocks comprising higher hydrocarbons, what is called a prereformer for preliminary cracking or preliminary reforming of the feedstock can be used downstream of the preheater. The precracked feedstock is then heated to the desired reformer tube inlet temperature in a further heater.

The hot synthesis gas product gas is partially cooled in one or more heat exchangers after leaving the reformer furnace. The partially cooled synthesis gas product gas then undergoes further conditioning steps dependent on the type of desired product or downstream process.

Steam reforming of natural gas is notable for its high energy demand. The prior art therefore already includes suggestions intended to minimize external energy requirements through optimized process design, for example through energy recovery. For instance Higman presented a so-called HCT reformer tube with internal heat exchange at the EUROGAS-90 conference, Trondheim, June 1990, also disclosed at http://www.higman.de/gasification/papers/eurogas.pdf (retrieved 27 Sep. 2011). This comprises an outer, catalyst-filled and externally heated reformer tube where the feed gas traverses the catalyst bed from top to bottom. Inside the catalyst bed are two coiled double helix heat exchanger tubes made of a suitable material through which the partially reformed gas flows after leaving the catalyst bed, thus transferring a portion of its sensible heat to the steam reforming process taking place over the catalyst. A disadvantage here, however, is the higher pressure drop on account of the longer distance travelled by the gas through the coiled heat exchanger tubes. A reformer tube with internal heat exchange that has been developed further on this basis is also taught in international patent application WO 2013/068416 A1.

In the further development of steam reforming technology, as well as the optimization of the heat budget of the reformer tube, a further target is that of minimizing the pressure drop, which brings economic advantages on account of the reduction in compression work required.

These two subject areas interact in that construction measures aimed at improvement of the heat budget in the reformer tube often increase the pressure drop across the reformer tube in an undesirable manner. If, therefore, the overall pressure drop over the reformer tube is to be kept constant or even reduced, the significant influencing parameter that remains is a reduction in the pressure drop over the reforming catalyst present.

One means of reducing the pressure drop over the reforming catalyst is that of using structured catalysts, for example in the form of structured packings containing a reforming catalyst, which gives rise to structured catalysts. A structured packing is understood by the person skilled in the art to mean—as opposed to unstructured packings or particle beds—specially designed vessel internals as used, for example, in absorber columns, distillation columns and fixed bed reactors. A structured packing often consists of thin, corrugated and perforated metal plates or wire meshes. In addition, it is possible to produce ceramic bodies that are then referred to as honeycombs. The design of the structured packings is intended to maximize their specific surface area and hence ensure optimal exchange between the different phases with minimal pressure resistance or pressure drop. In the case of a heterogeneously catalysed reaction such as steam reforming, therefore, the exchange area between the structured catalyst and the gas phase is to be maximized. A structured catalyst is accordingly understood to mean a structured packing containing a catalyst in that the catalyst is applied, for example, as a coating to the surface of the structured packing or embedded into the structural elements of the structured packing in the form of small particles.

The use of structured catalysts for the steam reforming of hydrocarbons is known per se and is described, for example, in patent publications EP 1 857 174 A1 and EP 1 944 269 A1.

US patent application US 2012/0195801 A1 describes the structure of structured catalysts associated with steam reforming. What are taught therein are stackable packing modules or segments arranged around a central guide rod. The packing segments have a fan or zigzag shape and are supported by a circular ring-shaped support element on their underside. The packing segments are manufactured from metal foils and are coated with a catalytically acting material, for example nickel which is active in respect of steam reforming. The fan shape results in formation of radial flow channels, and hence increases the dwell time of the feed gas in the structured packing. The reactor tube is filled with individual packing segments by stacking thereof.

In the case of endothermic processes, structured catalysts are known to have multiple advantages by comparison with conventional catalyst pellets. Structured catalysts have a higher coefficient of heat transfer and a greater geometric surface area than catalyst pellets. Both lead to improved reaction kinetics and higher conversion rates for a given catalyst volume. Moreover, structured catalysts have a higher proportion of cavities, which leads to a lower pressure drop for a given mass flow rate.

In the reforming of methane with steam or carbon dioxide, the use of a structured catalyst can improve internal heat transfer from the inner wall of the reformer tube to the process gas in two ways. Firstly, the high intrinsic coefficient of heat transfer of the structured catalyst increases the amount of heat supplied to the process fluid and hence the reaction rate and the degree of conversion. Secondly, the low pressure drop of the structured catalyst enables higher flow rates. Since internal heat transfer is also driven by convection, there is therefore an interest in increasing the mass flow rate as far as possible.

An increase in the mass flow rate also means a reduction in dwell time, with the result that the conversion of methane could be impaired. Structured catalysts, however, have a much greater available surface area for the reaction, which compensates for the reduced dwell time at higher flow rates.

Similarly to a construction with tubes having fins, a steam-methane reformer with structured catalyst can bring advantages by virtue of a higher reformer efficiency in order to lower natural gas consumption, or by virtue of the reduction in the number of tubes, in order to achieve savings in capital costs, as disclosed in EP 0 025 308 B1.

EP 0 305 203 A2 teaches that a low pressure drop and a high coefficient of heat transfer constitute the desired process conditions in steam-methane reforming. It is further taught that the advantage of use of structured catalyst rather than commercial catalyst pellets is that a higher transfer of wall heat and hence higher conversion rates are achieved without increasing the pressure drop. It is also taught that the highest degree of conversion is achieved for a given amount of catalyst when the highest possible temperature is employed. It follows that the operating temperature often approaches the upper temperature limit for the tube material, and that uniform temperature distribution along the tube wall is desirable since it enables the highest reforming temperature. Additionally taught are the advantages of a structured catalyst arrangement in order to achieve a uniform temperature distribution along the reformer tube.

EP 0 855 366 discloses various process parameters for the optimal use of a structured catalyst in the steam reforming of methane. In particular, operation at high mass flow rates is taught.

The use of structured catalysts rather than beds of solid catalyst particles accordingly opens up options for further optimization of the steam reforming process, especially for particular modes of operation such as the production of limited amounts of export steam. Steam reforming plants generate two main products in an efficient manner, namely synthesis gas and a product vapour stream that consists of multiple vapour substreams under some circumstances, which is released wholly or partly as export steam. The users of the synthesis gas product are often not the same as the recipients of the export steam. A disadvantage here is that discrepancies can therefore occur between synthesis gas production and the acceptance of the export steam since the production rates of the two products, synthesis gas and product steam, are coupled to one another, and the production rate of the export steam can be adjusted only to a very minor degree. There is therefore a continuing need for steam reforming processes that enable decoupling of the production rates of synthesis gas and steam, wherein the advantageous properties of structured catalysts are to be utilized.

### SUMMARY

The object of the present invention is therefore that of specifying a process for steam reforming of hydrocarbons with variable, especially with reduced, steam export, which utilizes the properties of structured catalysts that are especially disposed in reformer tubes having internal heat exchange.

This object is achieved in a general manner in a first aspect of the invention by a process having the features of claim 1, Further aspects of the invention are apparent from the dependent claims. The further aspects of the invention achieve the object of the invention in a particular manner, and in some cases in a preferred manner.

A fluid connection between two regions of the reformer tube is understood to mean any type of connection whatsoever which makes it possible for a fluid, for example the feed gas stream or the synthesis gas product stream, to flow from one to the other of the two regions, neglecting any interposed regions or components.

A heat exchange relationship is understood to mean the possibility of heat exchange or heat transfer between two regions of the reformer tube by any of the mechanisms of heat exchange or heat transfer such as heat conduction, heat radiation or convective heat transport.

Steam reforming conditions are understood to mean the process conditions known per se to a person skilled in the art, in particular of temperature, pressure and dwell time, as recited by way of example above and discussed in detail in the relevant literature and under which there is at least partial conversion but preferably industrially relevant conversions of the reactants to synthesis gas products such as CO and hydrogen. Accordingly, a catalyst active in respect of steam reforming is understood to mean a catalyst which brings about exactly such conversions under steam reforming conditions.

The terms “structured packing” and “structured catalyst” are familiar to the person skilled in the art and are used in the literature. In this regard, reference is made by way of example to the paper by M. Grünewald and U. Kunz, “Strukturierte Katalysatoren als Bausteine multifunktionaler Reaktoren” [Structured Catalysts as Components of Multifunctional Reactors], Chemie Ingenieur Technik 2007, 79, No. 9.

Reformer tubes with internal heat exchange are configured in the context of the present invention in such a way that there is a tube-in-tube arrangement in which an inner tube of relatively small diameter (heat exchanger tube) is disposed, preferably centrally, in an outer tube (shell tube). The annular gap that results therefrom is at least partly filled with catalyst, in the present invention preferably with structured catalyst. The reactants from the steam reforming, i.e. a preheated hydrocarbonaceous feed stream and steam, enter the shell tube via a gas inlet therein and are converted or at least partly converted over the catalyst disposed in the annular gap. After leaving the catalyst, the gaseous crude product from the steam reforming flows through the heat exchanger tube, preferably in countercurrent relative to the gas flow through the catalyst bed. What is essential here is that heat is transferred from the still-hot crude steam reforming product through the wall of the heat exchanger tube to the catalyst and/or the feed stream or already partly converted gas stream that flows through it. This improves the heat budget even within a reformer tube, such that less waste heat has to be removed by steam generation.

The crude synthesis gas product produced flows through the heat exchanger tube disposed within the structured catalyst to the gas outlet, in the course of which it releases a portion of its sensible heat in countercurrent to the structured catalyst, the feed gas stream that flows through it, and hence to the steam reforming process that proceeds over the catalyst. This especially improves radial heat transfer in the reformer tube. In one example, the heat exchanger tube may simultaneously have support and bearing functions for the structured catalyst or for the individual packing segments.

The term “bayonet reformer tube” is also used as an alternative designation for such reformer tubes with internal heat exchange, especially when the gas inlet and gas outlet are disposed at the same end of the tube and the other end of the tube is closed.

A process for producing a synthesis gas containing hydrogen and carbon oxides with variable steam export is understood to mean that the specific amount of export steam, measured in kg of steam per m_{N}³ of hydrogen produced, is varied by the changes in the process conditions according to the invention in an intended and reproducible manner with respect to a noninventive, conventional mode of operation of the process. In particular, a process for producing a synthesis gas containing hydrogen and carbon oxides with reduced steam export is understood to mean that the specific amount of export steam, measured in kg of steam per m_{N}³ of hydrogen produced, is reduced by the changes in the process conditions according to the invention in an intended and reproducible manner with respect to a noninventive, conventional mode of operation of the process.

The reforming temperature T_{ref} is understood to mean the temperature of the crude steam reforming product after exit from the catalyst bed or from the structured catalyst. It is measured by appropriate temperature measurement devices mounted at that site.

The normalized space velocity of the feed gas stream at the inlet into the reformer tubes is reported based on the volume of the structured catalyst in the unit m_{N}³/(s*m_{cat}³).

The reformer efficiency is understood to mean the percentage of he amount of heat generated by the burners that is transferred to the process gas.

The invention is based on the finding that the underlying problem can be solved in an advantageous manner with the general and particular aspects of the invention. This involves interaction of the following part elements and features:

(1) The configuration of the reformer tube as reformer tube with internal heat exchange enables an improvement in utilization of heat even within a reformer tube, such that less waste heat has to be removed by generation of steam.

(2) The use of a structured catalyst enables higher gas flow rates through the reformer tube and hence leads to better heat transfer from the crude steam reforming product stream to the catalyst and/or the feed stream or already partly converted gas stream that flows through it.

(3) For defined target ranges for the amount of export steam, namely:
zero steam exported,
small amount of export steam between 0 and 0.3 kg of export steam per m_{N}³ of hydrogen produced,
moderate amount of export steam between 0.3 and 0.8 kg of export steam per m_{N}³ of hydrogen produced,
   the features mentioned under (1) and (2) interact in a particularly advantageous and synergistic manner when particular steam reforming conditions as defined in detail in the claims are selected.

In a second aspect of the invention, the process is characterized in that the steam reforming conditions comprise a reforming temperature T_{ref} of at least 920° C., a steam/carbon ratio S/C of not more than 2.7 mol/mol and a normalized space velocity of the feed gas stream at the inlet into the reformer tubes between 2.5 and 3.0 m_{N}³/(s*m_{cat}³), and in that the specific amount of export steam is zero. Studies have shown that the selection of the steam reforming conditions mentioned achieves the object of the invention in a particular manner, such that the generation of export steam can be completely stopped.

In a third aspect of the invention, the process is characterized in that the steam reforming conditions comprise a reforming temperature T_{ref} of at least 930° C., a steam/carbon ratio SIC of not more than 2.7 mol/mol, preferably of not more than 2.4 mol/mol, and a normalized space velocity of the feed gas stream at the inlet into the reformer tubes between 3.5 and 4.0 m_{N}³/(s*m_{cat}³), and in that the specific amount of export steam is between 0 and 0.3 kg of steam per m_{N}³ of hydrogen generated. Studies have shown that the selection of the steam reforming conditions mentioned achieves the object of the invention in a particular manner, such that the generation of a small amount of export steam is enabled.

In a fourth aspect of the invention, the process is characterized in that the steam reforming conditions comprise a reforming temperature T_{ref} of at least 930° C., a steam/carbon ratio S/C of not more than 2.7 mol/mol, preferably of not more than 2.4 mol/mol, most preferably of not more than 2.1 mol/mol, and a normalized space velocity of the feed gas stream at the inlet into the reformer tubes between 3.0 and 3.5 m_{N}³/(s*m_{cat}³), and in that the specific amount of export steam is between 0.3 and 0.8 kg of steam per m_{N}³ of hydrogen generated. Studies have shown that the selection of the steam reforming conditions mentioned achieves the object of the invention in a particular manner, such that the generation of a moderate amount of export steam is enabled.

In a fifth aspect of the invention, the process is characterized in that the shell tube and the heat exchanger tube has a circular cross section and the structured catalyst has a circular ring-shaped cross section, and in that the shell tube, the structured catalyst and the heat exchanger tube are in a coaxial and concentric arrangement, wherein the structured catalyst is arranged with an essentially gastight seal between the inner wall of the shell tube and the outer wall of the heat exchanger tube, such that short-circuit flows along the inner wall of the shell tube and hence past the structured packing are minimized.

In a sixth aspect of the invention, the process is characterized in that the heat flow density between the outer wall and the inner wall of the shell tubes is between 50 and 200 kW/m², averaged over the length of the shell tubes. Studies have shown that the selection of the heat flow density mentioned achieves the object of the invention in a particular manner, such that the generation of amounts of export steam between zero and a moderate range for the amount of export steam is enabled.

In a seventh aspect of the invention, the process is characterized in that the inlet for the feed gas stream and the outlet for the crude synthesis gas product stream are disposed at the same end of the shell tube. What is thus obtained is the so-called bayonet design of the reformer tubes. This facilitates the installation and deinstallation of the reformer tubes in a reformer furnace, since only one end or side of the reformer furnace needs to be accessible here.

In an eighth aspect of the invention, the process is characterized in that the reformer tubes are arranged within the reformer furnace in an upright manner on a base of the reformer furnace or in a suspended manner from a roof of the reformer furnace, and the end of the shell tube at which the inlet for the feed gas stream and the outlet for the crude synthesis gas product stream are disposed projects out of the reformer furnace, with the opposite end of the shell tube disposed within the reformer furnace. This is particularly favourable since in this way thermomechanical stresses between the inlet for the feed gas stream and the outlet for the synthesis gas product stream which arise on account of the considerable temperature differences in the reformer tubes known from the prior art are avoided, in each of which the inlet end and the outlet end project out of the reformer furnace. In the case of the latter, costly and complex measures, for example the use of counterweight systems, of stress compensators (so-called pigtails) or of control cables, are therefore employed to compensate the stresses which occur and their adverse effects, for example deformation of the reformer tube. This is no longer necessary in the case of a suspended or upright arrangement of the reformer tube.

In a ninth aspect of the invention, the process is characterized in that a multitude of reformer tubes and burners are disposed in an interior of the reformer furnace, and in that the longitudinal axes of the flames generated by the burners are aligned parallel to the longitudinal axes of the reformer tubes, wherein the burners are disposed on the roof of the reformer furnace and/or at the base of the reformer furnace. This makes it possible to ensure that a burner achieves uniform heating of the reformer tubes arranged around it. Furthermore, the parallel flame axes supply radiated heat to the reformer tubes over a longer distance and local overheating of the outsides of the reformer tubes is avoided.

In a tenth aspect of the invention, the process is characterized in that the at least partially catalytic conversion of the feedstock is effected to an extent of at least 50% under steam reforming conditions in the reformer tubes to give the crude synthesis gas product, based on the hydrocarbons present in the feedstock.

In an eleventh aspect of the invention, the process is characterized in that at least one of the reformer tubes contains more than one kind of structured catalyst, wherein the type of structured catalyst relates to the material, structural or textural characteristics thereof and/or the specific catalytic activity thereof. What would be advantageous, for example, would be a configuration with a structured catalyst having a relatively high coefficient of heat transfer but also a relatively high pressure drop close to the gas inlet into the reformer tube, and with a structured catalyst having a relatively low coefficient of heat transfer but also a relatively low pressure drop close to the gas outlet from the reformer tube, since the temperatures and the gas volume flow rates are higher dose to the gas outlet from the reformer tube than dose to the gas inlet into the reformer tube. A favourable compromise is thus obtained between high heat transfer and low pressure drop.

In a twelfth aspect of the invention, the process is characterized in that the structured catalyst(s) comprise at least one element selected from the group of structured packings, monoliths, honeycombs, open-cell metallic, vitreous or ceramic foams, stacked wire meshes, wherein the elements each have catalytic activity for steam reforming.

Preference is given here to a structured catalyst in the form of a structured packing. This type of structured catalyst offers good heat transfer and pressure drop properties and can be configured such that the flow is directed preferentially onto the inner or outer wall of the reformer tube, in order to further improve the heat transfer. The support structure of the structured catalyst, in one example, consists of metallic material since this affords advantages with regard to more uniform thermal expansion with respect to the shell tube, and reduces thermomechanical stresses between shell tube and structured catalyst. In order to minimize corrosion of the materials in contact with gas by means of metal dusting corrosion, preference is given to providing the surface of the parts of the plant that are within the working range which is critical for metal dusting corrosion, for example in the temperature range between 400 and 800° C., with protection from corrosion, for example an aluminium layer. Experience has shown that these are essentially the regions between (in flow direction) the inner tube of the reformer tube and the waste heat boiler for steam generation.

### BRIEF DESCRIPTION OF THE DRAWING

Developments, advantages and possible applications of the invention are also apparent from the following description of working and numerical examples and the drawings. The invention is formed by all of the features described and/or depicted, either on their own or in any combination, irrespective of the way they are combined in the claims or the dependency references therein and wherein:

FIG. 1 an illustrative configuration of a reformer tube with internal heat exchange and structured catalyst for performance of the process according to the invention.

### DETAILED DESCRIPTION OF PREFERRED EMBODIMENTS

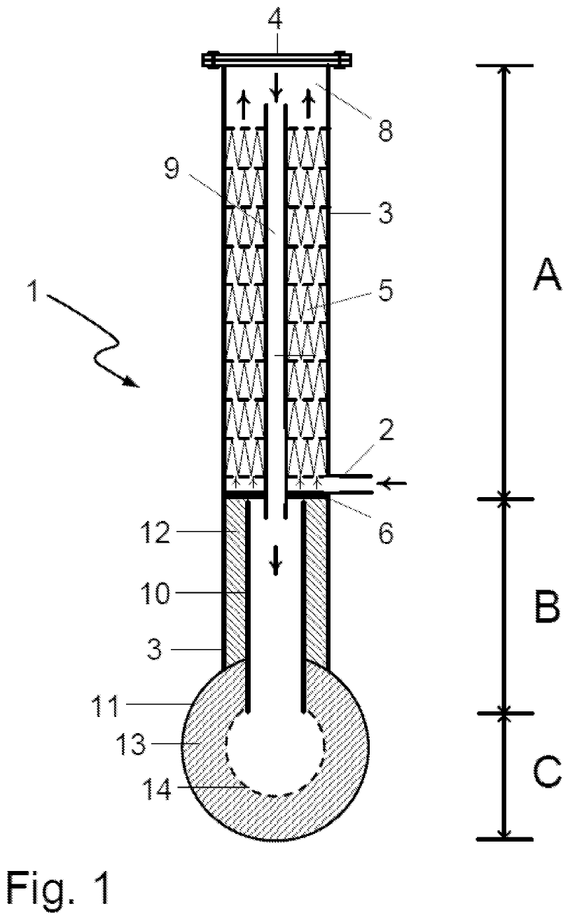

The reformer tube 1 according to the invention depicted in FIG. 1 is divided into the sections A (reaction chamber), B (outlet chamber) and C (collecting conduit).

Via an inlet conduit 2, desulfurized natural gas together with reforming steam enters the reaction chamber A arranged in the upper portion of a shell tube 3. The shell tube consists of a nickel-chromium steel for example of the type G-X45NiCrNbTi3525. The inlet temperature of the feed gas is 600° C.; the space velocity based on the catalyst volume is typically 4000 to 5000 m_{N}³/(m³ h).

In the present working example, the reformer tube is in an upright arrangement with the open tube end of the shell tube 3 in the upper position and is externally heated by means of burners (not shown in FIG. 1). During operation of the reformer tube, the open tube end of the shell tube is sealed with a sealing device 4, for example a flanged lid, which may be opened for inspection operations and for charging and discharging of the catalyst.

The natural gas and the reforming steam, after entering the shell tube, enter a structured catalyst 5 which is composed of individual packing segments and corresponds in terms of structure to the structured catalyst described in US 2012/0195801 A1. It has a specific surface area of 1100 m²/m³ and is equipped with a nickel-containing active layer which is catalytically active for the steam reforming. The structured catalyst is also structured such that a significant proportion of the gas flow is deflected radially. As a result, a portion of the gas flow hits the inner wall of the reaction tube, which improves radial heat transfer. However, the effect is limited, and so a further improvement in radial heat transfer as achieved with the reformer tube according to the invention is advantageous.

The feedstocks then flow upward through the structured catalyst, in the course of which the endothermic steam reforming reaction takes place. After leaving the structured catalyst, the partially converted natural gas comprising not only carbon oxides and hydrogen but also unconverted methane enters an open space 8 disposed at the sealed tube end 4 of the shell tube. The partly converted feed gas stream subsequently enters the inlet end of a straight heat exchanger tube 9 disposed within the catalyst bed. The gas stream flowing through the heat exchanger tube 9 releases a portion of its sensible heat in countercurrent to the catalyst bed and the feed gas stream flowing through it. The heat exchanger tube is made of materials having good resistance to metal dusting corrosion, for example Alloy 601, 602 CA, 617, 690, 692, 693, HR 160, HR 214, copper-containing alloys or what are called multilayer materials where the tubes are coated with tin-nickel or aluminium-nickel alloys. Alternatively or additionally, the outlet ends of the heat exchanger tube are equipped with an anticorrosion layer on the inside and also on the outside in the portions that are passed through the separation plate. In the present example, this is an aluminium diffusion layer.

After flowing through the heat exchanger tube, the synthesis gas product stream enters the outlet chamber B. For this purpose, the outlet end of the heat exchanger tube 9 is passed through a separation plate 6 and fixed in this manner. It then opens at the outlet end into an inner tube 10 that constitutes the connection between the heat exchanger tube 9 and a collecting conduit 11. The inner tube is likewise fabricated from one of the abovementioned metallic materials of construction and its inner wall and preferably also its outer wall are provided with an aluminium diffusion layer as a corrosion protection layer. Alternatively, it is also possible to use an inner tube produced from a ceramic material.

A gas-permeable insulating material 12 is mounted between the outer wall of the inner tube and the inner wall of the shell tube. For this purpose, it is possible to use fibre-based insulation materials, but also intrinsically dimensionally stable ceramic shaped bodies. The latter are particularly advantageous since they can be installed and deinstalled in a particularly simple manner. On account of their dimensional stability, they can be placed into the ring space between shell tube and inner tube in a simple manner on installation, without requiring any particular securing means.

The collecting conduit 11 is provided on its inside with insulation material 13 and/or a corrosion-resistant, for example ceramic, coating 14, which have elevated resistance to metal dusting corrosion. The synthesis gas product stream is discharged from the reformer tube 1 via the collecting conduit and is sent for further processing. Depending on the intended use of the synthesis gas product, this may comprise a carbon monoxide conversion, a gas scrubbing operation for removal of carbon dioxide, a pressure swing adsorption for hydrogen removal and further processing stages.

### EXAMPLES

The examples shown in the tables that follow are based on an equal production capacity of hydrogen and steam. All examples proceed from “End of Run” conditions (end of a catalyst cycle) with regard to catalyst activity.

The inventive examples are based on configurations of the reformer with bayonet tubes having structured catalyst. The export of steam is between 0 and 0.8 kg of steam per m_{N}³ of hydrogen produced. According to the invention, the reforming temperature is above 900° C. The invention gives some or all of the following advantages compared to processes according to the prior art: higher hydrocarbon conversion, higher reformer efficiency, lower total natural gas consumption, lower S/C ratio.

### Configurations of the Process for Steam Export of Zero or Low Steam Export (0 to 0.3 kg of Export Steam per m_{N}³ of Hydrogen Produced)

The prior art recommends providing a reduced number of reformer tubes for configurations of a reformer plant with bayonet tubes and structured catalyst in order to lower capital costs.

In a reformer plant without steam export, however, total hydrogen production costs are dominated essentially by natural gas consumption, and to a lesser degree by capital costs. Table 1 therefore compares various embodiments with bayonet tubes for the case of a reformer plant without steam export.

The configuration shown in Table 1, column 2, shows a design according to the prior art with bayonet tubes and catalyst pellets. This configuration has the following disadvantages:

(1) In order to prevent fluidization, a particular mass flow rate of feed gas must not be exceeded, which requires a high number of reformer tubes and/or a high tube diameter. This increases capital costs, and the lower mass flow rate per reformer tube reduces the coefficient of heat transfer.

(2) Catalyst pellet beds require a minimum ratio of pellet diameter to ring space in order to obtain an acceptable bed porosity and to avoid bypassing of the catalyst bed. This leads to a higher tube diameter that increases thermomechanical stresses, such that the maximum permissible tube thickness is attained at a lower reforming temperature, which limits performance aspects of the reformer, for example hydrocarbon conversion or reformer efficiency.

The configuration shown in Table 1, column 3, includes bayonet tubes with structured catalyst, with fewer tubes in the configuration proposed by the prior art than in the case of column 2. However, various adverse effects are observed when the number of tubes is reduced:

(1) The higher mass flow rate of feed gas per reformer tube leads to a lower dwell time, which is somewhat alleviated by the greater geometric surface area of the structured catalyst. Consequently, the system increasingly approaches the reaction equilibrium, which leads to a higher natural gas consumption for a given hydrogen production.

(2) For a given reformer output and reduced number of reformer tubes, there is a rise in the maximum wall temperature, which can have an adverse effect on the lifetime of the reformer tubes.

(3) The high maximum wall temperature leads to a maximum permissible tube wall thickness, which rules out any further increase in the reforming temperature.

(4) The reduced number of reformer tubes does not lead to significant savings in capital costs, since the structured catalyst is very costly compared to catalyst pellets.

Even in the case of a reformer plant with low steam export (0 to 0.3 kg of export steam per m_{N}³ of hydrogen produced), total hydrogen production costs are dominated essentially by natural gas consumption, and to a lesser degree by capital costs. Table 2 compares various embodiments with bayonet tubes for the case of a reformer plant with low steam export.

The cases shown in Table 2, column 2 and column 3, are configurations with catalyst pellets or with structured catalyst, with attempts being made in the case of column 3 to achieve savings with a reduced number of reformer tubes. While capital costs in configurations with low steam export influence economic viability to a somewhat greater degree than in the example without steam export, the disadvantages of the cases shown in column 2 and column 3 are essentially the same as in the cases in Table 1, column 2 and column 3.

### Configurations of the Process for Moderate Steam Export (0.3 to 0.8 kg of Export Steam per m_{N}³ of Hydrogen Produced)

The prior art suggests, in a steam reforming process with moderate steam export, configuring the reformer tubes as normal tubes with straight pass, i.e. without internal heat recovery, and with catalyst pellets or with structured catalyst. In the latter case, the prior art recommends, for example according to patent publications EP 1944269 B1 or U.S. Pat. No. 7,501,078 B2, a configuration with a reduced number of reformer tubes in order to achieve savings.

In a plant with moderate steam export, capital costs have a greater share of the total costs for hydrogen production than in a scenario without steam export or with low steam export, but overall economic viability is still unambiguously determined by natural gas consumption.

Table 3, for the case of a reformer plant with moderate steam export, compares various embodiments with normal tubes having a bed of pellets or structured catalyst and having bayonet tubes with structured catalyst. The case shown in column 2 has the following limitations:

(1) On account of the limited reformer efficiency of a configuration having normal tubes, the desired amount of export steam is already attained at a moderate reforming temperature. Since other operating parameters, for example the combustion air preheating temperature, have already reached their respective upper limits, the reforming temperature cannot be increased further without producing more steam, which would reduce the overall thermal efficiency of the reforming process.

The case shown in Table 3, column 3, includes a configuration with normal tubes having straight pass without heat recovery with structured catalyst and a reduced number of reformer tubes. However, this configuration leads to various disadvantages:

(1) It is not possible to increase the reforming temperature without producing excess steam, which reduces the overall thermal efficiency of the reforming process.

(2) The reduced number of reformer tubes does not lead to significant savings in capital costs, since the structured catalyst is very costly compared to catalyst pellets.

### Configurations According to the Invention

Inventive configurations of steam reforming processes without steam export or with low steam export (0 to 0.3 kg of export steam per m_{N}³ of hydrogen produced) have the following features, the aim of which is to increase the reformer efficiency and reforming temperature as far as possible:

In the inventive configuration shown in Table 1, column 4, the tube diameter is reduced and the number of reformer tubes is increased to overcome mechanical limitations. This permits increasing the reforming temperature above 900° C. The reduction in the tube diameter is possible by virtue of the use of the structured catalyst, which can be matched to the small diameter and ring space.

The increased reforming temperature moves the reaction equilibrium in the direction of a higher hydrocarbon conversion in the reformer, and simultaneously increases the efficiency of the reformer (reformer efficiency) and reduces total natural gas consumption, even though the exchange area for heat exchange has decreased compared to the reference case in column 2. The cases shown in columns 2 and 3 are limited on account of the high tube thickness of the reformer tubes with regard to the maximum achievable reforming temperature.

In the case of inventive configurations of steam reforming processes with moderate steam export (0.3 to 0.8 kg of export steam per m_{N}³ of hydrogen produced), it would not be very practicable to provide a bayonet tube with catalyst pellets, since the limits for various process parameters would already be achieved at lower steam export values. This is especially true of the reforming temperature, which is in turn limited by the maximum tube wall thickness. However, the use of structured catalyst even for moderate steam export allows bayonet tubes to be used rather than normal tubes, which achieves the following advantages:

(1) The significantly higher reforming temperature in the inventive case of Table 3, column 4, leads to a higher hydrocarbon conversion, a higher reformer efficiency and a lower overall natural gas consumption than in the cases with normal tubes, columns 2 and 3, without formation of an excess of steam by virtue of the internal heat recovery.

(2) On account of the utilization of the sensible heat from the crude synthesis gas produced, this high hydrocarbon conversion and a higher reformer efficiency can be achieved without increasing the average external heat flow from the burners to the reformer tubes and with a reduced number of reformer tubes by comparison with the cases shown in Table 3, columns 2 and 3.

(3) In addition, it is possible in this way to lower the S/C ratio in the steam reforming, which is advantageous in relation to capital costs and operating costs.

TABLE 1
Process conditions for steam reforming processes without steam export

| | | Bayonet tube, | |
|---|---|---|---|
| | | structured catalyst, | Bayonet tube, |
| | Bayonet tube, | reduced number | structured catalyst |
| | bed of pellets | of tubes | (invention) |
| Reforming temperature T_{ref} (° C.) | 885 | 885 | 930 |
| Steam/carbon S/C (mol/mol) | 3.05 | 3.05 | 2.65 |
| Heat flow density per tube (kW/m²) | 64.9 | 80.5 | 78.4 |
| Normalized space velocity | 1.22 | 3.49 | 2.89 |
| at reformer inlet (m_{N}³/s/m³) | | | |
| Methane conversion (%) | 75.9 | 75.1 | 83.5 |
| Reformer efficiency (%) | 61.23 | 57.30 | 62.09 |
| Exchange area (m²) | 846.9 | 682.2 | 800.0 |
| Number of reformer tubes in the | 144 | 116 | 164 |
| reformer furnace | | | |
| Total natural gas consumption | 20660 | 20699 | 20181 |
| (feed gas + heating gas) | | | |
| Internal shell tube diameter (m) | 0.125 | 0.125 | 0.100 |
| Shell tube wall thickness (m) | 0.0155 | 0.0155 | 0.0147 |

TABLE 2
Process conditions for steam reforming processes with low steam
export (0 to 0.3 kg of export steam per m_{N}³ of hydrogen produced)

| | | Bayonet tube, | |
|---|---|---|---|
| | | structured catalyst, | Bayonet tube, |
| | Bayonet tube, | reduced number | structured catalyst |
| | bed of pellets | of tubes | (invention) |
| Reforming temperature T_{ref} (° C.) | 877 | 877 | 935 |
| Steam/carbon S/C (mol/mol) | 2.91 | 2.91 | 2.36 |
| Heat flow density per tube (kW/m²) | 65.2 | 95.2 | 107.8 |
| Normalized space velocity | 1.22 | 3.90 | 3.89 |
| at reformer inlet (m_{N}³/s/m³) | | | |
| Methane conversion (%) | 75.8 | 75.0 | 81.6 |
| Reformer efficiency (%) | 57.57 | 54.46 | 58.35 |
| Exchange area (m²) | 841.4 | 607.7 | 637.0 |
| Number of tubes in the reformer | 144 | 104 | 160 |
| furnace | | | |
| Total natural gas consumption | 21469 | 21497 | 20721 |
| (feed gas + heating gas) | | | |
| Internal shell tube diameter (m) | 0.125 | 0.125 | 0.076 |
| Shell tube wall thickness (m) | 0.015 | 0.015 | 0.0148 |

TABLE 3
Process conditions for steam reforming processes with moderate steam
export (0.3 to 0.8 kg of export steam per m_{N}³ of hydrogen produced)

| | | | Bayonet tube, |
|---|---|---|---|
| | Normal tube, | Normal tube, | structured catalyst |
| | bed of pellets | structured catalyst | (invention) |
| Reforming temperature T_{ref} (° C.) | 890 | 890 | 934 |
| Steam/carbon S/C (mol/mol) | 2.38 | 2.38 | 2.02 |
| Heat flow density per tube (kW/m²) | 85.1 | 104.2 | 85.6 |
| Normalized space velocity | 1.19 | 3.03 | 3.16 |
| at reformer inlet (m_{N}³/s/m³) | | | |
| Methane conversion (%) | 78.1 | 77.5 | 83.3 |
| Reformer efficiency (%) | 51.40 | 51.40 | 56.65 |
| Exchange area (m²) | 1338.2 | 1093.3 | 1176.2 |
| Number of tubes in the reformer | 306 | 250 | 240 |
| furnace | | | |
| Total natural gas consumption | 33353 | 33403 | 32664 |
| (feed gas + heating gas) | | | |
| Internal shell tube diameter (m) | 0.100 | 0.100 | 0.100 |
| Shell tube wall thickness (m) | 0.008 | 0.008 | 0.015 |

### LIST OF REFERENCE SYMBOLS

[1] Reformer tube

[2] Inlet conduit

[3] Shell tube

[4] Sealing apparatus

[5] Structured catalyst

[6] Separation plate

[7] Catalyst bed

[8] Open space

[9] Heat exchanger tube

[10] Inner tube

[11] Collecting conduit

[12] Insulating layer

[13] Insulating layer

[14] Coating

[A] Reaction chamber

[B] Outlet chamber

[C] Collecting conduit

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for producing a synthesis gas containing hydrogen and carbon oxides with reduced steam export by catalytic steam reforming of a hydrocarbonaceous feed gas with steam under steam reforming conditions in a multitude of reformer tubes in a burner-heated reformer furnace, with formation of a steam reforming flue gas,
the reformer tubes comprising the following constituents:
(a) an outer, pressure-rated shell tube heated by means of the burners and having an inlet for a feed gas stream and an outlet for a crude synthesis gas product stream,
(b) at least one structured catalyst which is catalytically active in respect of steam reforming and disposed within the shell tube, having an inlet end and an outlet end,
(c) a heat exchanger tube which is disposed within the shell tube and within the structured catalyst, the inlet end of which is in fluid connection with the outlet end of the structured catalyst, and the outlet end of which is in fluid connection with the outlet for the crude synthesis gas product stream,
(d) configured such that the feed gas stream is introduced into the shell tube via the inlet and flows first through the structured catalyst and subsequently through the heat exchanger tube in countercurrent, and the crude synthesis gas product stream produced is discharged from the shell tube via the outlet,
(e) configured such that the heat exchanger tube and the gas stream that flows through it are in a heat-exchanging relationship with the structured catalyst and the gas stream that flows through it,
the process comprising:
(f) providing the hydrocarbonaceous feed gas and adding reforming steam and/or carbon dioxide,
(g) at least partly catalytically converting the feed gas under steam reforming conditions in the reformer tubes to a crude synthesis gas product containing carbon oxides and hydrogen, wherein the steam reforming conditions comprise a reforming temperature T_{ref} of at least 900° C., a steam/carbon ratio S/C of not more than 2.8 mol/mol and a normalized space velocity of the feed gas stream at the inlet into the reformer tubes between 2 and 5 m_{N}³/(s*m_{cat}³),
(h) discharging the crude synthesis gas product from the reformer tubes,
(i) discharging the reforming flue gas from the reformer furnace,
(j) cooling at least a portion of the reforming flue gas and/or of the crude synthesis gas product by indirect heat exchange with cooling water to generate steam which can be discharged at least partly from the process as export steam, wherein the specific amount of export steam is between 0 and 0.8 kg of steam per m_{N}³ of hydrogen generated.

2. The process according to claim 1, wherein the steam reforming conditions comprise a reforming temperature T_{ref} of at least 920° C., a steam/carbon ratio S/C of not more than 2.7 mol/mol and a normalized space velocity of the feed gas stream at the inlet into the reformer tubes between 2.5 and 3.0 m_{N}³/(s*m_{cat}³), and in that the specific amount of export steam is zero.

3. The process according to claim 1, wherein the steam reforming conditions comprise a reforming temperature T_{ref} of at least 930° C., a steam/carbon ratio S/C of not more than 2.7 mol/mol, and a normalized space velocity of the feed gas stream at the inlet into the reformer tubes between 3.5 and 4.0 m_{N}³/(s*m_{cat}³), and in that the specific amount of export steam is between 0 and 0.3 kg of steam per m_{N}³ of hydrogen generated.

4. The process according to claim 1, wherein the steam reforming conditions comprise a reforming temperature T_{ref} of at least 930° C., a steam/carbon ratio S/C of not more than 2.7 mol/mol, and a normalized space velocity of the feed gas stream at the inlet into the reformer tubes between 3.0 and 3.5 m_{N}³/(s*m_{cat}³), and in that the specific amount of export steam is between 0.3 and 0.8 kg of steam per m_{N}³ of hydrogen generated.

5. The process according to claim 1, wherein the shell tube and the heat exchanger tube has a circular cross section and the structured catalyst has a circular ring-shaped cross section, and in that the shell tube, the structured catalyst and the heat exchanger tube are in a coaxial and concentric arrangement, wherein the structured catalyst is arranged with an essentially gastight seal between the inner wall of the shell tube and the outer wall of the heat exchanger tube.

6. The process according to claim 1, wherein the heat flow density between the outer wall and the inner wall of the shell tubes is between 50 and 200 kW/m², averaged over the length of the shell tubes.

7. The process according to claim 1, wherein the inlet for the feed gas stream and the outlet for the crude synthesis gas product stream are disposed at the same end of the shell tube.

8. The process according to claim 7, wherein the reformer tubes are arranged within the reformer furnace in an upright manner on a base of the reformer furnace or in a suspended manner from a roof of the reformer furnace, and the end of the shell tube at which the inlet for the feed gas stream and the outlet for the crude synthesis gas product stream are disposed projects out of the reformer furnace, with the opposite end of the shell tube disposed within the reformer furnace.

9. The process according to claim 1, wherein a multitude of reformer tubes and burners are disposed in an interior of the reformer furnace, and in that the longitudinal axes of the flames generated by the burners are aligned parallel to the longitudinal axes of the reformer tubes, wherein the burners are disposed on the roof of the reformer furnace and/or at the base of the reformer furnace.

10. The process according to claim 1, wherein the at least partially catalytic conversion of the feedstock is effected to an extent of at least 50% under steam reforming conditions in the reformer tubes to give the crude synthesis gas product, based on the hydrocarbons present in the feedstock.

11. The process according to claim 1, wherein at east one of the reformer tubes contains more than one kind of structured catalyst, wherein the type of structured catalyst relates to the material, structural or textural characteristics thereof and/or the specific catalytic activity thereof.

12. The process according to claim 1, wherein the structured catalyst(s) comprise at least one element selected from the group of:
structured packings, monoliths, honeycombs, open-cell metallic, vitreous or ceramic foams, stacked wire meshes, wherein the elements each have catalytic activity for steam reforming.
